(19) United States
(12) Patent Application Publication
(10) Pub. No.: US 2004/0252829 A1
(43) Pub. Date: Dec. 16, 2004

(54) Montgomery modular multiplier and method thereof using carry save addition

(76) Inventor: Hee-Kwan Son, (US)

Correspondence Address: HARNESS, DICKEY & PIERCE, P.L.C., P.O. BOX 8910, RESTON, VA, 20195, US

(21) Appl. No.: 10/736,832

(22) Filed: Dec. 17, 2003

(30) Foreign Application Priority Data
Apr. 25, 2003 (KR) P2003-26482

(51) Int. Cl. H04L 9/00; G06F 7/38

(52) U.S. Cl. 380/30; 708/491

(57) ABSTRACT

A method for power reduction and increasing computation speed for a Montgomery modulus multiplication module for performing a modulus multiplication. A coding scheme reduces the need for an adder or memory element for obtaining multiple modulus values, and the use of carry save addition with carry propagation addition increases the computational speed of the multiplication module.

### CROSS-REFERENCE TO RELATED APPLICATIONS

The present application claims priority from a Korean application having Application No. P2003-26482, filed 25 Apr. 2003 in Korea, the disclosure of which is incorporated herein in its entirety by reference.

### FIELD OF THE INVENTION

The present invention relates to the field of cryptosystems and, more particularly, to a Montgomery modular multiplier and method using carry save addition.

### BACKGROUND OF THE INVENTION

For speed of computation of cryptosystems, fast exponential computation becomes important. One method used to accelerate computation is the Montgomery modular multiplication algorithm. The Montgomery modular multiplication algorithm provides a n-bit number:

ti R=A*B*r⁻¹mod N, (where the radix r=2ⁿ) (1)

required in the modular exponential algorithm, where A, B, and N are the multiplicator, multiplicand, and modular number, respectively, and each has n bits.

A conventional hardware implementation of a Montgomery modular multiplication algorithm is shown in FIG. 1, which utilizes a multiple modulus selector 1, a Booth Recoder 12, and an accumulator 2. The multiple modulus selector 1 selects a value for the multiple modulus (0, M, 2M, and 3M) and outputs the selected value to a carry propagation adder (CPA) 14. Obtaining a value of 3M requires an additional adder, increasing the hardware size and decreasing computational speed. CPA 14 is one of two carry propagation adders in the accumulator 2, the other is CPA 11. Each CPA added to the accumulator increases the overall propagation delay time and decreases computational speed. CPA 11 receives a partial product value from a multiplicand selector 13 and P[i], a previous value of the output of the accumulator 2. The multiplicand selector 13 receives the multiplicator and the output of the Booth Recoder 12 to obtain a partial product value (−2A, −A, 0, A, 2A). CPA 11 adds the partial product and P[i]. The output of CPA 11 is input to CPA 14 along with the value for the multiple modulus to obtain a resultant accumulation value for the i+1 iteration, P[i+1], obtaining a result for the Montgomery multiplication P[i+1]=ABR⁻¹mod M.

### SUMMARY OF THE INVENTION

Exemplary embodiments of the present invention provide for methods of accelerating the speed of Montgomery modular multiplication and/or reducing power consumption by using a coding scheme which eliminates the need for an additional adder or memory when obtaining the multiple modulus value.

In exemplary embodiments of the present invention, a carry save adder (CSA) is used instead of a CPA in an accumulator to improve computation speed and propagation delay.

In exemplary embodiments of the present invention, a coding scheme eliminates the need for an adder or memory element for obtaining the multiple modulus value.

Further areas of applicability of embodiments of the present invention will become apparent from the detailed description provided hereinafter. It should be understood that the detailed description and specific examples, while indicating exemplary embodiments of the invention, are intended for purposes of illustration only and are not intended to limit the scope of the invention.

### BRIEF DESCRIPTION OF THE DRAWINGS

Embodiments of present invention will become more fully understood from the detailed description and the accompanying drawings, wherein:

FIG. 1 is an illustration of a background art hardware implementation of a Montgomery modular multiplication algorithm;

FIG. 2 is an illustration of a modular multiplier of an exemplary embodiment of the present invention;

FIG. 3 is a table describing selection criteria for the multiple of modulus MM_{I} in an exemplary embodiment of the present invention;

FIG. 4 is a table describing selection criteria for the partial product PP_{I} in an exemplary embodiment of the present invention;

FIG. 5 is an illustration of an accumulator of an exemplary embodiment of the present invention;

FIG. 6 is an illustration of a complete compressor of an exemplary embodiment of the present invention;

FIG. 7 is an illustration of a reduced compressor of an exemplary embodiment of the present invention; and

FIG. 8 is an illustration of an accumulator of an exemplary embodiment of the present invention.

FIG. 9 is an illustration of a configuration of a kth bit multiplexer of an exemplary embodiment of the present invention.

### DETAILED DESCRIPTION OF EXEMPLARY EMBODIMENTS OF THE PRESENT INVENTION

The following description of exemplary embodiment(s) is merely illustrative in nature and is in no way intended to limit the invention, its application, or uses.

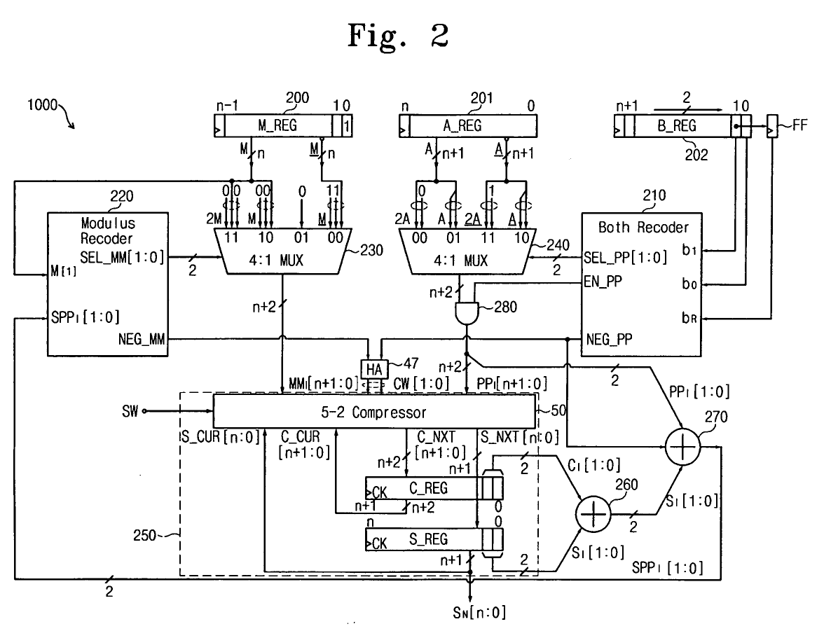

FIG. 2 illustrates a modular multiplier 1000 of an exemplary embodiment of the present invention. The multiplier 1000 can include a modulus (M) stored in a register 200, a multiplicand (A) stored in a register 201, a multiplicator (B) stored in a register 202, a Booth recoder 210, a Modulus recoder 220, a multiplexer (MUX) 230 aiding in the computation of the multiple modulus MM_{I}, a MUX 240 aiding in the computation of the partial product PP_{I}, and an accumulator 250 for aiding in the computation of the modular multiplication. The accumulator 250 can input a partial product value PP_{I}, a multiple modulus value MM_{I}, and a compensating word signal (CW) and produce a result for the Montgomery multiplier. In exemplary embodiments of the present invention, the positive value M has n bits (M[n−1:0]). The positive or negative value A has n+1 bits (A[n:0]), one bit for a sign bit, and the multiplicator B has even bits. If n is even, B can have n+2 bits, two bits being sign bits. Or if n is odd, B can have n+1 bits, one bit being a sign bit.

In exemplary embodiments of the present invention, register 200 provides the modulus M and M, where M is the one's complement of M. Similarly register 201 provides the multiplicand A and A, where A is the one's complement of A and register 202 provides the multiplicator B.

The multiplier 1000 can solve for modular multiplication in an iterative process. The Modulus recoder 220 and the multiplexer 230 are used to select multiple modulus (MM_{I}) values. To select MM₁ values, the Modulus recoder 220 receives iterative data from the accumulator 250. In an exemplary embodiment of the present invention the iterative data, SPP_{I}[1:0], is based on the two LSBs of values in a sum (S_{I}[1:0]) and carry (C_{I}[1:0]) registry of the accumulator 250, two LSBs of the partial product value (PP_{I}[1:0]), and a partial product negation indicating signal NEG_PP. C_{I}[1:0] and S_{I}[1:0] can be combined in a two-bit adder 260 to form a combined signal. The combined signal can be combined with PP_{I}[1:0] and NEG_PP in a two-bit adder 270 to form SPP_{I}[1:0]. In addition to SPP_{I}[1:0] the Modulus recoder 220 inputs the second least significant bit of the Modulus, M[1]. The Modulus recoder 220 uses SPP_{I}[1:0] and M[1] to generate output signals, which can determine the selection of a multiple modulus MM_{I} value. The discussion above, with respect to exemplary embodiments of the present invention, is not intended to limit the bit size of values. SPP_{I} can have more than two bits, as can other elements of the embodiment (e.g., adder 260 can be more or less than a two-bit adder).

The Modulus recoder 220 can output multiple signals (e.g., a multiple modulus selection signal SEL_MM[1:0], a multiple modulus negation indicating signal NEG_MM, . . . ). In an exemplary embodiment of the present invention, the Modulus recoder outputs SEL_MM[1:0] to the multiplexer 230, which uses the value of SEL_MM[1:0] to select one of four possible values of MM_{I} (e.g., 2M, M, 0, M). The multiplexer (MUX) 230 inputs the modulus M and, in an exemplary embodiment, two LSBs of the multiple modulus selection signal SEL_MM[1:0], outputing the value of MM_{I}. MM_{I} is sent to the accumulator 250. The multiple modulus negation indicating signal NEG_MM can be combined in a half adder 47 with the partial product negation indicating signal NEG_PP to obtain the compensatory word signal CW. CW is sent to the accumulator 250.

NEG_MM is used to indicate whether the selected value of MM_{I} should be bit-inverted. Likewise NEG_PP is used to indicate whether the selected partial product PP_{I} should be bit-inverted. The PP_{I} value is based upon operations performed by the Booth recoder 210, the multiplexer 240 and an AND gate 280. PP_{I} is sent to the accumulator 250 along with MM_{I} and CW.

Although FIG. 2 illustrates the use of 4:1 multiplexers (MUX), exemplary embodiments of the present invention are not limited to a particular ratio value of the multiplexer, nor is the accumulator limited to a 5-2 compressor. For example one 4-1 MUX can be replaced by three 2-1 MUXs.

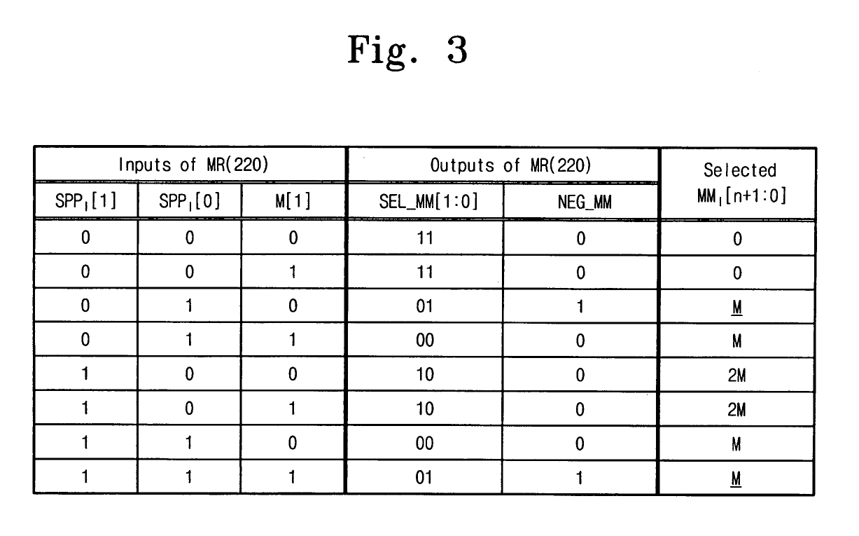

FIG. 3 illustrates a coding scheme in accordance with exemplary embodiments of the present invention. Although FIG. 3 shows three inputs to the Modulus recoder 220, M[1] and SPP₁[1:0], the present invention can have a variety of inputs and outputs depending upon the design criteria. Typical values of the multiple modulus MM_{I} are (0, M, 2M, 3M). As described above the value 3M requires an additional adder or memory element to add 1M to 2M to obtain the value of 3M. An additional adder and/or memory element contributes to hardware size and/or computational delay, which affects computational speed and power usage. The coding scheme shown in FIG. 3 utilizes bit-inversion and bit-shift to obtain the value of MM_{I} without an additional adder or memory element. The Modulus recoder 220 inputs M[1], the second least significant bit of the Modulus M, and, in an exemplary embodiment, SPP_{I}[1:0], two LSBs of SPP_{I}. Modulus recoder 220 outputs a modulus selection signal SEL_MM[1:0]. SEL_MM[1:0] is used to select one of four possible multiple modulus numbers (0, M, M, 2M). The signal NEG_MM indicates whether a bit-inversion is used, obtaining M. The resultant selected multiple modulus value MM_{I} is sent to the accumulator 250. The discussion above, with respect to exemplary embodiments of the present invention, is not intended to limit the bit size of values. SPP_{I} can have more than two bits as can other elements of the embodiment.

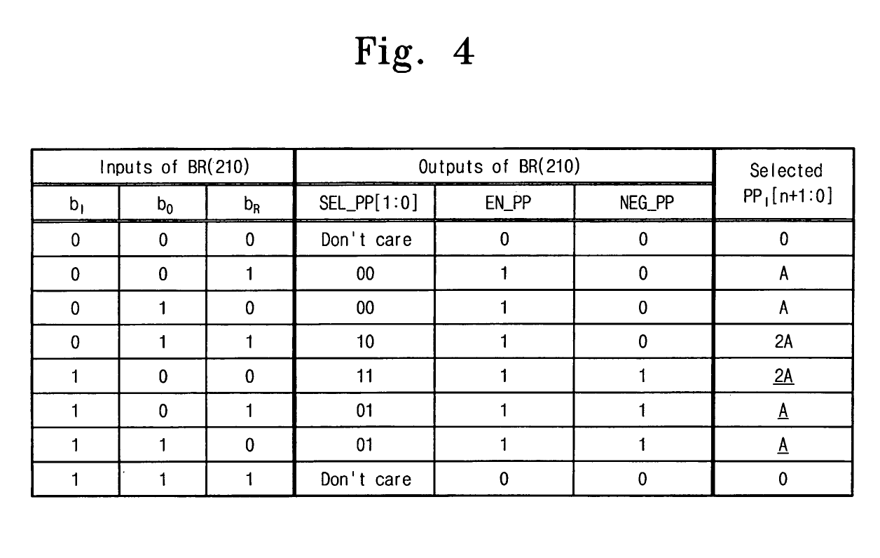

In another exemplary embodiment of the present invention, a similar method of decreased hardware size, increased computational speed and power reduction can be used with the Booth recoder 210 as shown in FIG. 2 and 4. As mentioned above the multiplier 1000 solves for modular multiplication in an iterative process, which includes the supply of MM_{I} and partial product values (PP_{I}) to the accumulator 250. The Booth recoder 210 and multiplexer 240 are used to select partial product (PP_{I}) values (e.g. 0, A, 2A, A, 2A) to supply to the accumulator 250. The Booth recoder 210 inputs the two LSBs of the multiplier (B[1] and B[0]) and B[r], a previous iteration's value of B[1] and outputs three signals, a partial product selection signal SEL_PP[1:0], a partial product enablement signal EN_PP, and a partial product negation indicating signal NEG_PP.

To select PP_{I} values, the Booth recoder 210 outputs the partial product selection signal SE_PP[1:0] to the multiplexer 240 for selecting one of four possible values (2A, A, A, 2A). The multiplexer 240 receives the value of the multiplicand (A) and SEL_PP[1:0] and outputs a value to an AND gate 280. The AND gate 280 receives the input from the multiplexer 240 and a partial product enabling signal EN_PP from the Booth recoder 210. The AND gate 280 outputs the selected value of the partial product (PP_{I}) to the accumulator 250. When EN_PP has a zero value the AND gate 280 outputs a zero value for PP_{I} to the accumulator 250. The partial product negation signal NEG_PP is input to the half adder 47. A value of 1 for NEG_PP indicates that a bit-inversion should be performed on PP_{I} obtaining one of the values 2A or A for a new PP_{I} value input to the accumulator 250.

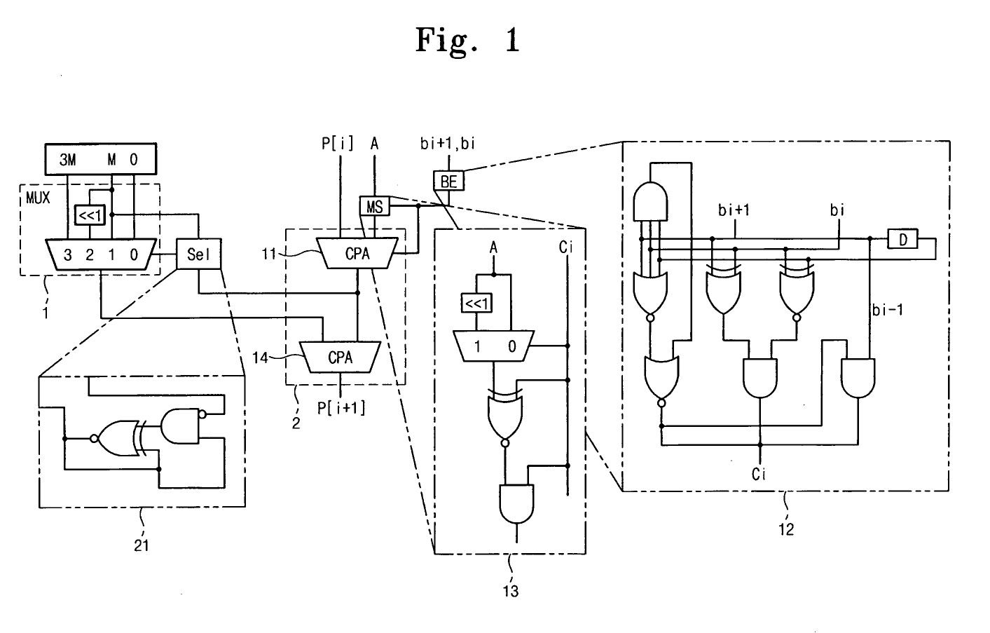

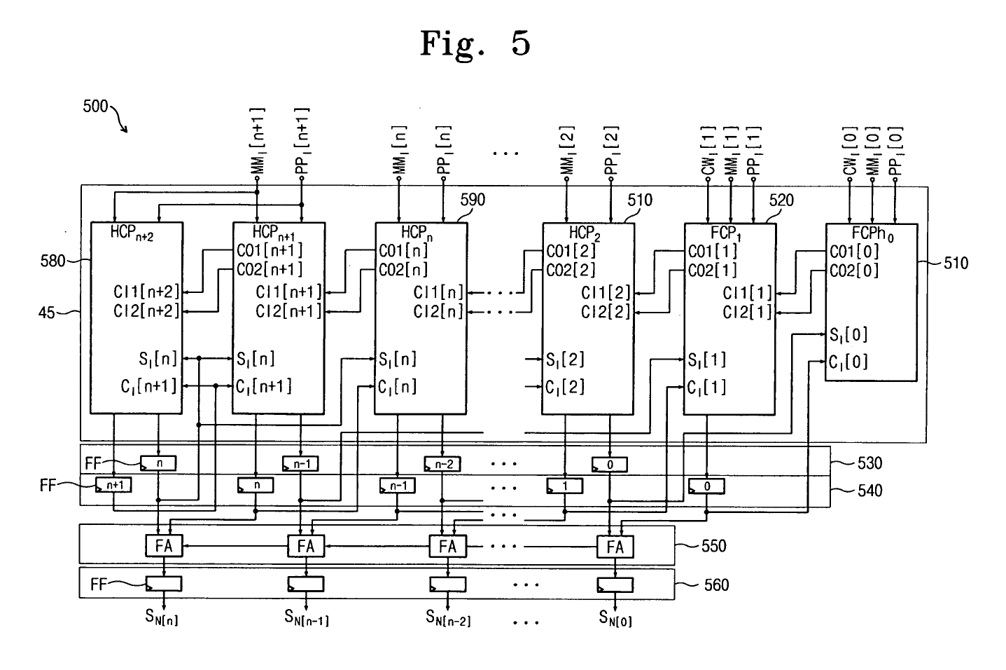

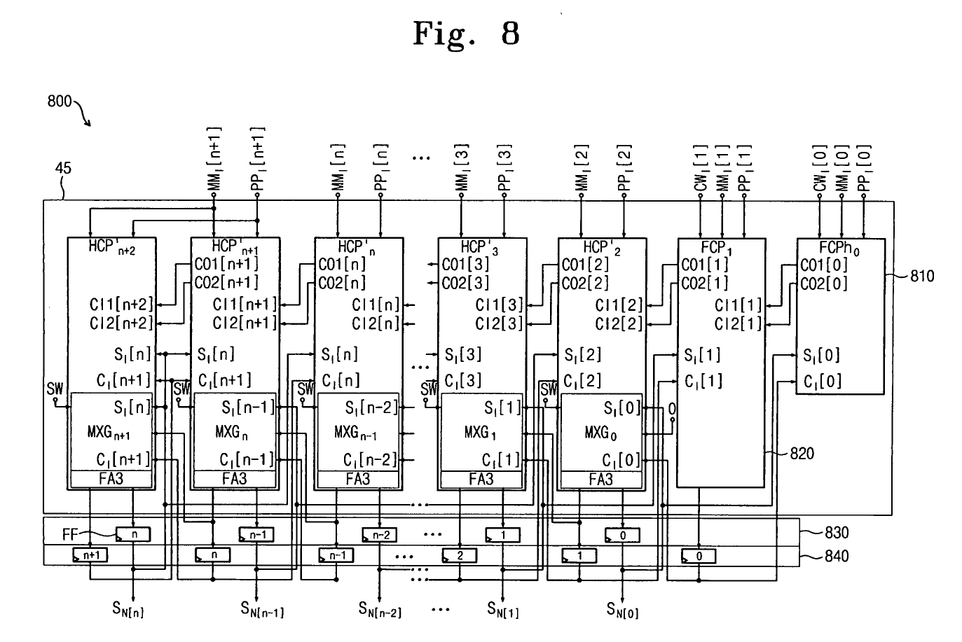

In addition to PP_{I} and MM_{I} values, the compensating word signal (CW) is sent to the accumulator 250 from the half adder 47. The accumulator 250 inputs PP_{I}, MM_{I}, and CW into a combination of full and half compressors, which are used to add in a carry save adder (CSA) and propagate in a carry propagate adder (CPA). Conventional accumulators (FIG. 1) use CPAs in each iteration, which as discussed above, results in accumulated propagation delay resulting in a low operating frequency. Use of a CSA reduces accumulated propagation delay increasing computation speed and decreasing computation power usage resulting in a high operating frequency. Exemplary embodiments of the present invention utilize a combination of CSA and CPA to increase computation speed and decrease power usage. For example, in an exemplary embodiment of the present invention, only one CPA is used during the final iteration, while the previous iterations use a CSA. FIGS. 5 and 8 show two exemplary embodiments of the present invention and are for illustrated purposes only and not intended to limit the scope of the present invention to a particular configuration of use of CSA and a CPA.

An exemplary accumulator 500 in accordance with the present invention is illustrated in FIG. 5. The accumulator is composed of n+2 series of 5-2 compressors, broken into full compressors (e.g., 520) and reduced compressors (e.g., 510), where n is the bit length of modulus value M. The accumulator 500 stores sum (S) and carry (C) values in a sum register 530 (S_REG) and a carry register 540 (C_REG), respectively. The outputs of the S_REG 530 and the C_REG 540 are input to a carry propagation adder 550, which converts a redundant number to a normal number, storing the value in a final register 560 (F_REG).

Input to the accumulator 500, in an exemplary embodiment of the present invention, are compensating word CW[1:0], the multiple modulus value MM_{I} and the partial product value PP_{I}. The first two full compressors, 570 and 520, input CW[1:0] along with MM_{I}[1:0] and P_{I}[1:0]. The remaining reduced compressors 510, 580, 590, etc. use the remaining bits of the multiple modulus value MM_{I}[n+1:2], and the partial product value PP_{I}[n+1:2]. The last compressor 580 (n+2 compressor) prevents overflow and the first compressor 570 (n=0) is a full compressor missing a third full adder. Other exemplary embodiments can have a various number of bits for the various variable values (e.g., CW, MM_{I}, PP_{I}, . . . ) and discussion herein should not be interpreted to limit the bit sizes of the variables.

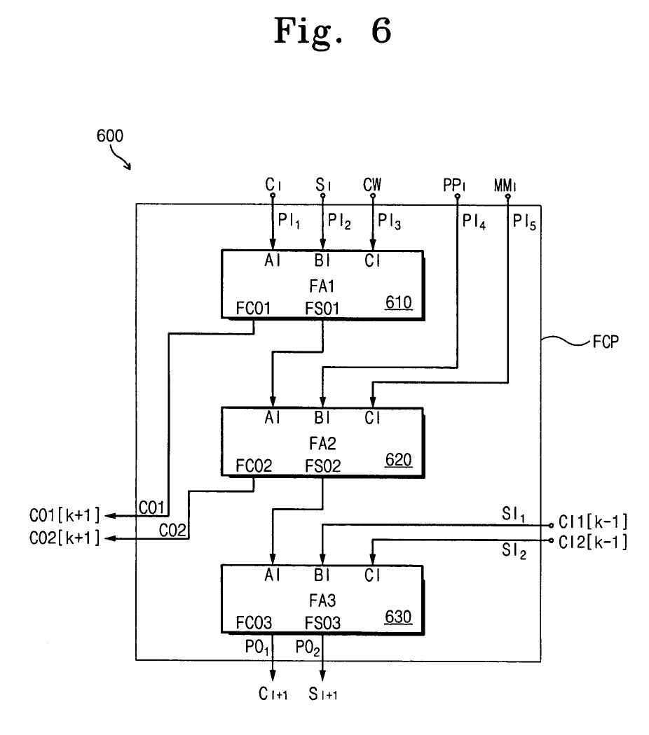

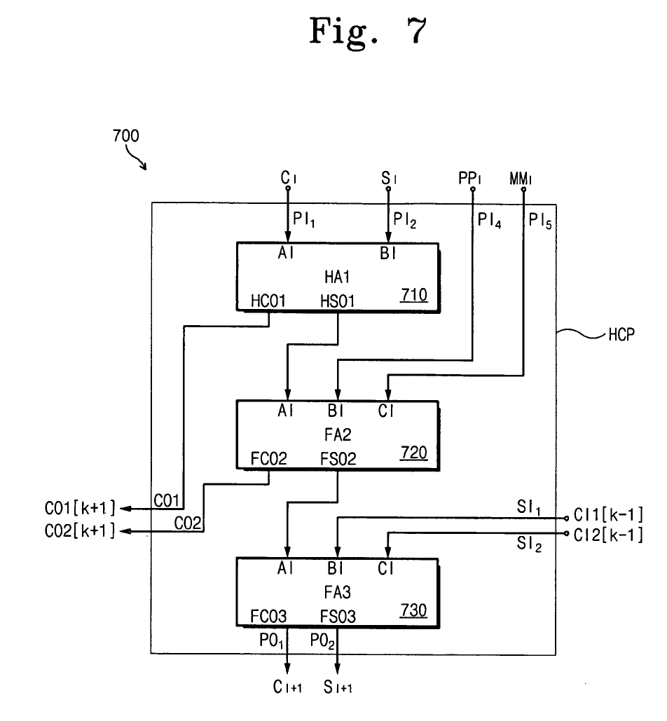

Exemplary configurations of full 600 and reduced 700 compressors are shown in FIGS. 6 and 7, respectively. Each compressor is used to obtain a next value (I+1) using a current value (I) and other inputs. FIG. 6 illustrates a full compressor 600 in accordance with an exemplary embodiment of the present invention. The full compressor 600 can have a plurality of inputs. In an exemplary embodiment a full compressor 600 can have five inputs, a current carry word bit value (C_{I}) obtained from a next carry word bit value from a compressor one bit higher, a current sum word bit value (S_{I}) obtained from a next sum word bit value from a compressor two bits higher, a compensating word value (CW), a partial product value (PP_{I}), and a multiple modulus value (MM_{I}). It is noted that inputted current carry word bit value have an index of “I” in the current compressor, whereas when leaving the higher bit compressor a value is output as the next carry word bit value C_{I+1}[k+1], where k represents the current “kth” compressor or kth-bit compressor. The next carry word bit value C_{I+1}[k+1] is input to the carry register 540, which outputs the current carry word bit value C_{I} to the kth compressor, as indicated above. The current sum word bit value S_{I}[k] is likewise obtained by a next sum word bit value from the k+2 compressor S_{I+1}[k+2] input to the sum register 530. The values are used by the full compressor 600 to obtain next carry word bit and next sum word bit values for the particular bit k, C_{I+1}[k] and S_{I+1}[k] respectively. These values are then passed to their respective carry and sum registers 540 and 530 (as shown in FIG. 5). The outputs of the carry and sum registers, 540 and 530 respectively, serve as inputs to lower bit compressors as described above. The next carry word bit (C_{I+1}[k]) and next sum word bit (S_{I+1}[k]) values can be related by Equation (2).

(2C_{I+1}[k]+2CO1[k]+2CO2[k]+S_{I+1}[k])=(C_{I}[k]+S_{I}[k])+PP_{I}[k]+MM_{I}[k]+CW[k]+CI1[k]+CI2[k] (2)

where if k>1, CW[k] is not an input and is effectively 0.

In an exemplary embodiment of the present invention the full compressor 600 is composed of three full adders. The first full adder 610 inputs the values C_{I}, S_{I}, and CW and outputs a first full adder carry (FCO1) and a first full adder sum (FSO1). FCO1 serves as a first output carry CO1, which can be a secondary first input CI1[k+1] for the next higher bit compressor (k+1). The second full adder 620 inputs FSO1, the partial product bit value PP_{I}[k] and the multiple modulus bit value MM_{I}[k] associated with the bit designation (k) of the compressor. The second full adder 620 outputs a second full adder carry (FCO2) and a second full adder sum (FSO2). FCO2 serves as a first output carry CO2, which can be a secondary second input CI₂[k+1] for the next higher bit compressor (k+1). The third full adder 630 inputs FSO2, and CI1[k−1] and CI2[k−1] from a lower bit compressor (k−1). The third full adder 630 outputs a third full adder carry (FCO3) and a third full adder sum (FSO3). FCO3 serves as the next carry word bit value C_{I+1}, which is used to obtain the input C_{I} to a lower bit compressor (k−1). FSO3 serves as the next sum word S_{I+1}, which is used to obtain the input S_{I} to a two bits lower compressor (k−2). The first full compressor 570 corresponding to bit 0 does not output next carry or sum words, thus the third full adder is not needed. Likewise the second full compressor 520 corresponding to bit 1 does not output a next sum word bit value.

The compensating word CW[1:0] has two bits and thus requires two compressors, one for each bit. Thus, the first two compressors, 570 and 520, are full compressors inputting a plurality of values. In exemplary embodiments the full compressors 570 and 520 input five values. The higher bit compressors [2:n+2] input a plurality of values that are less than that input to compressors 570 and 520 and are referred to as reduced compressors 510. Reduced compressors replace the first full adder with a half adder. Thus, the half adder 710 in the reduced compressor inputs the values C_{I} and S_{I} and outputs a first half adder carry (HCO1) and a first half adder sum (HSO1). HCO1 serves as a first output carry CO1, which can be a secondary first input Cl1[k+1] for the next higher bit compressor (k+1). The second full adder 720 inputs HSO1, the partial product bit value PP_{I}[k] and the multiple modulus bit value MM_{I}[k] associated with the bit designation (k) of the compressor. The second full adder 720 outputs a second full adder carry (FCO2) and a second full adder sum (FSO2). FCO2 serves as a second output carry CO2, which can be a secondary second input CI2[k+1] for the next higher bit compressor (k+1). The third full adder 730 inputs FSO2, and CI1[k−1] and CI2[k−1] from a lower bit compressor (k−1). The third full adder 730 outputs a third full adder carry (FCO3) and a third full adder sum (FS03). FCO3 serves as the next carry word bit C_{I+1}, which serves as input C_{I} to a lower bit compressor (k−1) after passing to the carry register 540. FS03 serves as the next sum word bit S_{I+1}, which serves as input S_{I} to a two bits lower compressor (k−2) after passing to the sum register 530.

The accumulator 500 of FIG. 5, in accordance with an exemplary embodiment of the present invention, links in series full compressors and reduced compressors, the number of which depends on the input bit size of the multiple modulus value (MM_{I}) and the partial product value (PP_{I}). The two LSB compressors are full compressors that use the compensating word (CW) as an input. The first bit compressor 570 outputs CO1[0] and CO2[0], which become secondary inputs to the next higher bit (second bit) compressor 520, CI1[1] and CI2[1] respectively. This continues until the highest bit compressor (n+2), which does not output carry outputs (CO1[n+2] and CO2[n+2]). The highest bit compressor prevents overflow and its secondary inputs are obtained from its own next carry word bit and next sum word bit values.

Each compressor's next carry word bit value and next sum word bit value are passed to their respective carry and sum registers 540 and 530, respectively. The final results are generated in a separated form (redundant number) one part stored in the sum register 530 and the other part stored in the carry register 540. To obtain the final single word result S_{N}[n:0] the value stored in the sum register 530 and the value stored in the carry register 540 are added in a carry propagation adder (CPA) 550, and the final single word result S_{N}[n:0] is stored in a final register (F_REG) 560. The use of the CSA mode instead of a pure CPA mode of the conventional systems is that, for example in the exemplary system describe in FIG. 5, the CSA compressors have three delay paths, one associated with each adder. In a conventional accumulator, a delay path exists for each bit.

Thus, for the exemplary embodiment of the present invention shown in FIG. 5, three delay paths exist for all of the compressors combined, regardless of the bit size n, since they are configured using carry save addition. In a conventional system, there would be “n” delay paths. Thus, the exemplary configuration can significantly improve the computational speed of a modular multiplication. For example, in a 1024 bit multiplier a conventional system will have an accumulator with 1024 delay (full adder paths) whereas exemplary embodiments of the present invention would have only the path delays associated with a single full compressor or reduced compressor, e.g., 3. Thus, in this example, a multiplier based on an exemplary embodiment of FIG. 5 would be 300 times faster than the conventional system. In an exemplary embodiment of the present invention shown in FIG. 5, a CPA is used only once.

Other exemplary embodiments of the present invention include a variety of combinations of switching between CSA and CPA modes in the accumulator. For example, FIG. 8 illustrates an accumulator 800 according to an exemplary embodiment of the present invention, where multiplexers MXGₙ₊₁ to MXG₀ are used in combination with the compressors to switch between CPA and CSA mode when desired. Such a configuration no longer has a CPA 550 to convert a redundant number to a normal number. The accumulator 800 shown in FIG. 8 is selectively worked in the CSA or CPA mode, thus the output is already in normal number format. Removing the CPA 550 reduces the size of the hardware needed.

The multiplexers (MXGₙ₊₁ to MXG₀) can control the electrical connections between full adders in the compressors. As shown in FIG. 8, the first two bit compressors 870 and 820 are analogous to the description and operation of the compressors 520 and 570, respectively, except that the next carry word bit value (C_{I+1}[k]) is not only passed to the carry register 840 to obtain a current carry word bit value C_{I}[k−1], used by the lower bit compressor 870, C_{I+1}[k] is passed to the next higher bit compressor [k+1] as input to a multiplexer associated with the higher bit compressor MXGₖ₋₂

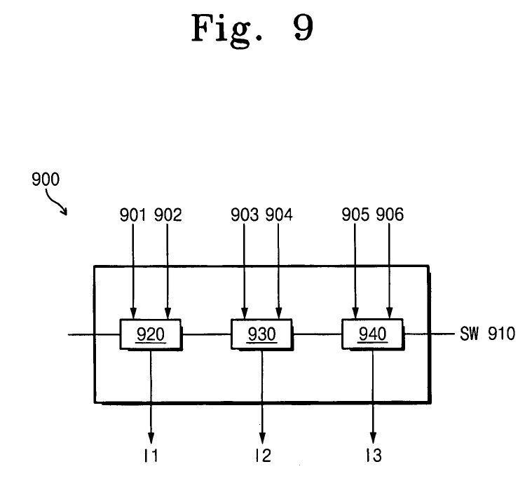

FIG. 9 illustrates a configuration of a kth bit multiplexer 900 in accordance with exemplary embodiments of the present invention. The computation mode (using CSA or using CPA) can be controlled by a switching signal (SW) 910. In an exemplary embodiment of the present invention, the kth bit multiplexer 900 can be placed between the second adder 720 and the third adder 730 of the reduced compressor 700 of FIG. 7. Thus, the first input 901 into the first element 920 of the multiplexer 900 is FSO2 from adder 720, described above. The second input 902 to the first element 920 is the current carry word bit value (C_{I}[k−1]) from the k−1 bit compressor, where the current carry word bit value is obtained from the next carry word bit value for the k−1 bit compressor, C_{I+1}[k−1], that has been passed to the carry register 840. The second element 930 of the multiplexer 900 inputs two values, the first 903 is the first output carry value, CO1[k−1], from the k−1 bit compressor (also the first secondary input to the kth bit compressor, CI1[k]), and the second 904 is the current sum word bit value S_{I}[k] of the kth bit compressor, where the current sum word bit value is obtained by passing the next sum word bit value S_{I+1}[k] to the sum register 830. The third element 940 of the multiplexer 900 also inputs two values, the first 905 is the second output carry value , CO2[k−1], from the k−1 bit compressor (also the second secondary input to the kth bit compressor, CI2[k]), and the second 906 is the next carry word bit value for the k−1 bit compressor, C_{I+1}[k−1].

The switching signal, SW 910, determines which of the two input values to each element 920, 930, and 940 pass to the third full adder 730. Depending on which values are passed determines which mode of operation occurred, a carry save addition or a carry propagation addition. If the value of SW 910 is zero then the compressors are operated in carry save addition mode. If the value is one then the bottom full adders of the compressors are connected in series and operated in carry propagation addition mode. The full adder 730 outputs a next carry word bit value and a next sum word bit value as described above. The exemplary embodiment described above uses two inputs per element 920, 930, and 940. The present invention is not limited to a particular number of inputs and other exemplary embodiments in accordance with the present invention have a plurality of inputs and a plurality of elements and multipliers.

Carry and sum words are computed during N iterations, where N is (n+2)/2 if n is even or (n+1)/2 if n is odd. Carry and sum values outputted in a current iteration cycle are added with those of a previous iteration cycle and stored in the carry register 840 (C_REG) and the sum register 830 (S_REG). The final result S_{N}[n:0] is obtained by adding carry and sum in the registers 830 and 840 respectively by varying the desired switching value SW 910.

The exemplary embodiment shown in FIG. 8 allows a reduction in the hardware size since multiplexers may have much smaller size than the CPA adder 550 plus the F_REG 560.

The description of the invention is merely exemplary in nature and, thus, variations that do not depart from the gist of the invention are intended to be within the scope of the embodiments of the present invention. Such variations are not to be regarded as a departure from the spirit and scope of the present invention. For example multiplexers 230 and 240 can have a variety of ratio values. Likewise the multiplexers used in exemplary embodiments of the present invention, for example as shown in FIG. 8 can be composed of a single multiplexer or individual multiplexers with varying inputs. Likewise the controlling signal can be switched so that a value of zero signifies the use of the CPA mode as opposed to the CSA mode and vice versa. Further variations of the exemplary embodiments of the present invention described herein will become apparent to one of ordinary skill in the art, such variations are intended to lie within the scope of the present invention.

What is claimed is:

1. A multiple modulus selector comprising:
a modulus recoder for receiving a n-bit modulus number M and a previous sum and a current partial product and producing a selection signal; and
a multiplexer for receiving four inputs −M, 0, M, and 2M and selecting one of the inputs based on the selection signal.

2. The multiple modulus selector of claim 1, wherein the input −M is obtained by inverting the modulus number M.

3. The multiple modulus selector of claim 1, wherein the input 2M is obtained by shifting the modulus number M.

4. The multiple modulus selector of claim 1, wherein the modulus number M is stored in a register.

5. The multiple modulus selector of claim 1, wherein the modulus recoder further produces a multiple modulus negation indicating signal NEG_MM, wherein the negation indicating signal is input to an accumulator.

6. The multiple modulus selector of claim 1, wherein the n-bit modulus number M includes a next least significant bit M[1] and the previous sum and current partial product is a two bit number, including a least significant bit SPP_{I}[0] and a next least significant bit SPP_{I}[1].

7. The multiple modulus selector of claim 1, wherein the selection signal includes two bits SEL_MM [1:0].

8. An accumulator, comprising:
a plurality of compressors for operating in a carry save mode, each of the plurality of compressors receiving a multiple modulus, a partial product, a corresponding current sum, and a corresponding current carry and producing a corresponding next sum and a corresponding next carry;
a sum register for receiving the corresponding next sum from each of the plurality of compressors and outputs a corresponding updated current sum; and
a carry register for receiving the corresponding next carry from each of the plurality of compressors and outputs a corresponding updated current carry.

9. The accumulator of claim 8, wherein the sum register and carry register are separate registers.

10. The accumulator of claim 8, wherein the multiple modulus is produced from a modulus.

11. The accumulator of claim 10, wherein n is the bit length of the modulus and the plurality of compressors include n+3 compressors.

12. The accumulator of claim 11, wherein the modulus is stored in an n-bit register.

13. The accumulator of claim 8, wherein the partial product is produced from a multiplicand and a multiplicator.

14. The accumulator of claim 13, wherein n+1 is the bit length of the multiplicand.

15. The accumulator of claim 14, wherein the multiplicand is stored in an (n+1)-bit register.

16. The accumulator of claim 13, wherein if n is even, then n+2 is the bit length of the multiplicator and if n is odd, then n+1 is the bit length of the multiplicator.

17. The accumulator of claim 16, wherein if n is even, the multiplicator is stored in an (n+2)-bit register and if n is odd, the multiplicator is stored in an (n+1)-bit register.

18. The accumulator of claim 8, wherein each of the plurality of compressors is a 5:2 compressor.

19. The accumulator of claim 8, a first group of the plurality of compressors further receiving a compensating word to produce the corresponding next sum and the corresponding next carry.

20. The accumulator of claim 19, wherein the first group of the plurality of compressors are full compressors.

21. The accumulator of claim 19, wherein a second group of the plurality of compressors does not receive the compensating word.

22. The accumulator of claim 21, wherein the second group of the plurality of compressors are reduced compressors.

23. The accumulator of claim 8, wherein each of the partial product and the multiple modulus are n+2 bits.

24. The accumulator of claim 19, wherein the compensating word is 2 bits.

25. The accumulator of claim 19, wherein the full compressor is composed of three full adders.

26. The accumulator of claim 22, wherein the reduced compressor is composed of one half adder and two full adders.

27. The accumulator of claim 8, further comprising:
a carry propagate adder for receiving a finally updated current sum and a finally updated current carry and outputs a final sum in normal number representation; and
a final register for storing the final sum.

28. The accumulator of claim 8, wherein the plurality of compressors operate in both the carry save mode and a carry propagate mode.

29. The accumulator of claim 9, wherein the carry save mode and the carry propagate mode are determined by a control signal.

30. The accumulator of claim 28, a first group of the plurality of compressors further receiving a compensating word to produce the corresponding next sum and the corresponding next carry.

31. The accumulator of claim 30, wherein the first group of the plurality of compressors are full compressors.

32. The accumulator of claim 30, wherein a second group of the plurality of compressors does not receive the compensating word.

33. The accumulator of claim 32, wherein the second group of the plurality of compressors are reduced reconfigurable compressors.

34. The accumulator of claim 33, wherein each of the reduced reconfigurable compressors includes:
a multiplexer group for reconfiguring each of the reduced reconfigurable compressors to operate in both the carry save mode and the carry propagate mode.

35. The accumulator of claim 34, wherein each multiplexer group includes three 2:1 multiplexers.

36. The accumulator of claim 33, wherein each of the reduced reconfigurable compressors includes a multiplexer group which reconfigures the reduced reconfigurable compressor to operate in either the carry save mode or the carry propagate mode according to the control signal.

37. The accumulator of claim 36, where the carry save mode includes a first signal flowing from a middle full adder of a current compressor to a bottom full adder of the current compressor, a second signal flowing from -a top adder of -a lower compressor to the-bottom full adder of the current compressor, and a third signal flowing from a middle full adder of the lower compressor to the bottom full adder of the currentcompressor.

38. The accumulator of claim 36, where the carry propagate mode includes a first signal flowing from a bottom full adder of a lower compressor to the multiplexer group of a higher compressor and a second signal flowing from the multiplexer group of the higher compressor to a bottom full adder of the higher compressor.

39. The accumulator of claim 33, wherein each of the reduced reconfigurable compressors includes:
a multiplexer group for receiving a sum of a middle full adder of the current compressor, a corresponding updated current carry of a lowercompressor, a first and second secondary output of the lowercompressor, the updated current sum of the currentcompressor, and the corresponding next carry of the lowercompressor and outputting first through third outputs.

40. The accumulator of claim 31, wherein the full compressor is composed of three full adders.

41. The accumulator of claim 33, wherein the reduced reconfigurablecompressor is composed of one half adder, two full adders and three 2:1 multiplexers.

42. A Montgomery multiplier comprising:
a multiple modulus selector, wherein the selector selects a multiple modulus from one of −M, 0, M, and 2M, where M is an n-bit modulus number;
a booth recoder, wherein the booth recoder provides first values used to obtain a partial product value; and
an accumulator, wherein the accumulator accumulates second values obtaining a result for the Montgomery multiplier.

43. The multiplier of claim 42, further comprising:
a modulus number register, wherein the modulus number register holds a modulus value;
a multiplicand register, wherein the multiplicand register holds a multiplicand value;
a multiplier register, wherein the multiplier register holds a multiplier value;
an AND gate, where the AND gate combines two values derived from the multiplicand value and the multiplier value; and
two adders, wherein the adders combine values from the accumulator and the AND gate producing a combined value, where the multiple modulus selector inputs the combined value.

44. A method of multiple modulus generation, comprising:
receiving a modulus;
receiving a previous sum and a current partial product, wherein the modulus and the previous sum and a current partial product are used to produce multiple modulus values of −M, 0, M, and 2M.

45. The method of claim 44, further comprising receiving only a portion of the modulus, the portion being the second least significant bit of the modulus.

46. The method of claim 44, further comprising receiving only a portion of the previous sum and a current partial product, the portion being the two least significant bits of the previous sum and a current partial product.

47. The method of claim 44, further producing a selection signal, where the selection signal is used to select a value of the produced multiple modulus values.

48. The method of claim 47, further producing a multiple modulus negation indicating signal, where the modulus negation indicating signal is used to produce a complement of the selected value.

49. A method of partial product generation, comprising:
receiving a multiplier number; and
generating a partial product selection signal, a partial product enabling signal, a partial product negation indicating signal to produce at least one partial product value.

50. The method of claim 49, further comprising shifting the multiplier number by two bits.

51. A method of accumulating, comprising:
receiving a plurality of multiple modulus, partial products, corresponding current sums, and corresponding current carries for producing a corresponding next sum and next carry;
generating updated current sums and updated current carries;
iterating the receiving and generating steps until a multiplier operand is consumed to generate a result in redundant representation; and
performing carry propagation addition to generate a result in normal representation.

52. The method of claim 51, wherein the step of iterating is carry save addition performed by a carry save adder.

53. The method of claim 51, wherein the step of performing is carry propagation addition performed by a carry propagation adder.

54. The method of claim 53, further comprising the step of generating a switching signal.

55. The method of claim 54, further comprising switching between carry save addition and the carry propagation addition using the switching signal.

56. A method of performing radix 2^{N} Montgomery multiplication, where N>1, comprising;
receiving a multiplicand, a modulus, and a multiplier;
performing carry save addition on a plurality of inputs related to the multiplicand, modulus, and multiplier to generate a result in redundant representation; and
performing carry propagation addition to generate a result in normal representation.

57. The method of claim 56, wherein the carry save addition is performed by a carry save adder and the carry propagation addition is performed by a carry propagation adder.

58. The method of claim 56, wherein the carry save addition and the carry propagation addition is performed by an accumulator.

59. The method of claim 56, further comprising the step of generating a switching signal.

60. The method of claim 59, further comprising switching between the carry save mode and the carry propagation mode using the switching signal.

61. A method of performing radix 2^{N} Montgomery multiplication, where N>1, comprising;
receiving a multiplicand, a modulus, and a multiplier;
performing accumulation in carry save mode on a plurality of inputs related to the multiplicand, modulus, and multiplier to generate a result in redundant representation; and
performing conversion in carry propagation mode on the result in redundant representation to generate a result in normal representation.
